(19) United States
(12) Patent Application Publication
(10) Pub. No.: US 2026/0141507 A1
(43) Pub. Date: May 21, 2026

(54) GENERATIVE ARTIFICIAL INTELLIGENCE FOR DATA SYNTHESIS

(71) Applicant: UnitX, Inc., Santa Clara, CA (US)

(72) Inventor: Di Meng, Santa Clara, CA (US)

(21) Appl. No.: 18/951,429

(22) Filed: Nov. 18, 2024

(51) Int. Cl. G06T 7/00; G06T 5/60

(52) U.S. Cl. CPC G06T 7/001; G06T 5/60; G06T 2207/20081; G06T 2207/20221

(57) ABSTRACT

In an example embodiment, generative artificial intelligence (GAI) is used to synthesize data to be used to train and/or validate a segmentation model. A GAI model may be fine tuned with real training data, but then may be able to generate its own data. The data is image data, and the GAI model may use a real background image and then generate a fake defect and insert the fake defect in the proper place in the real background image.

### TECHNICAL FIELD

This application relates generally to machine learning. More particularly, this application relates to the use of generative artificial intelligence for data synthesis.

### BACKGROUND

Machine learning can be used in a variety of applications to perform various classification actions on digital images. One such classification is to identify “defects” in items appearing in the digital images. For example, a manufacturer may capture images of a product or part on an assembly line and use a machine learning model to identify whether the product or part has a defect that necessitates correction or destruction of the product.

Traditionally, training of such models has utilized two-dimensional images, but most of the products or parts being evaluated are three dimensional in nature, and have points, lines, and curves that may not be easily understood by a model trained using only two-dimensional images.

### BRIEF DESCRIPTION OF DRAWINGS

FIG. 1 is a diagram illustrating an image showing a product, in accordance with an example embodiment.

FIG. 2 is a diagram illustrating a mask over a product image, in accordance with an example embodiment.

FIG. 3 is a block diagram illustrating a system, in accordance with an example embodiment.

FIG. 4 is a flow diagram illustrating a method for training a segmentation model, in accordance with an example embodiment.

FIG. 5 is a block diagram illustrating a software architecture, in accordance with an example embodiment.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and computing machine program products that have illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

One particular way that artificial intelligence models are used in defect detection is through a segmentation model. The goal of a segmentation model is to segment an image into smaller segments to improve reliability of subsequent modeling (such as subsequent classification and defect detection models). Thus, for example, a segmentation model may be used to identify particular portions of an image of an image that are likely to have defects, which then allows the subsequent classification and defect detection models to only focus on those particular portions of the image (or at least use the segments in its analysis).

Training of a segmentation model involves using training data with a machine learning algorithm. The training data may be labeled (such as labeled with indications of which segments of each image in the training data are likely to have defects). The labels may be stored in the form of masks, which essentially are overlays on the image with areas of interest highlighted or marked in some way, as well as some classification (label) of the areas of interest. For example, a particular defect in a product in a sample image may be circled and classified as “defect”, while the remaining part of the image showing the product may be classified as “non-defect” and any non-product part (e.g., part of an assembly line) of the image classified as “non-product”. The machine learning algorithm then repeatedly modifies weights and other parameters in the segment model until it is “trained” to accurately predict the segments of interest in the training data. At that point, the segmentation model is considered trained and can be used to evaluate images that have no labels (e.g., new images taken after the segmentation model has been trained). Furthermore, some of the “training data” may be held back and not actually be used for training, but instead be used for validation, such as to validate that the segmentation model has been properly trained after training. That data, while similar or identical to training data, may be termed “validation data.”

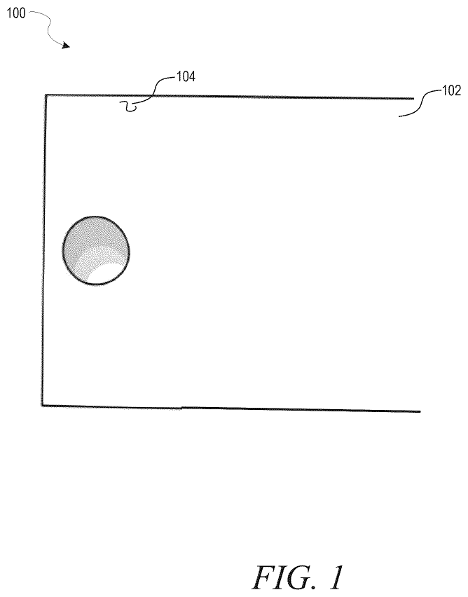

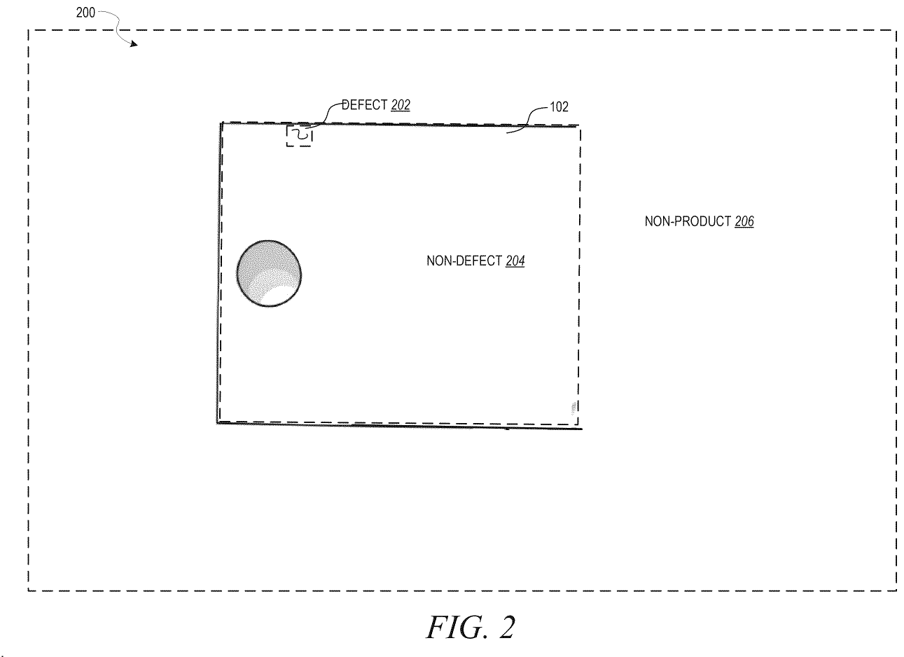

FIG. 1 is a diagram illustrating an image 100 showing a product 102, in accordance with an example embodiment. Here, the product is shown to have a defect 104. FIG. 2 is a diagram illustrating a mask 200 over a product image, in accordance with an example embodiment. Specifically, the mask 200 delineates three portions. Each portion is depicted as bordered by dashed lines, which are not actually present in the mask but are provided to be able to tell where one portion ends and another begins. The first portion 202 is labeled as “non-product”, specifically the portion of the image that does not contain the product. The second portion 204 is labeled as “non-defect,” specifically the portion of the image that contains the product but that represents the non-defective portion of the product. The third portion 206 is labeled as “defect,” specifically the portion of the image that contains the defective portion of the product.

A technical issue that arises with the training of segmentation models is data insufficiency. There may be a lack of available labeled data, or at least a lack of available data with certain types of labels, making it difficult to accurately train (or validate) the segmentation model. This issue is exacerbated in the case of segmentation models used in a defect detection pipeline, because defects in products are rare and thus training data of actual products with actual defects is also rare. In ten thousand images of products there may only be a single defect in a single image. Finding relevant training data is, therefore, difficult.

In an example embodiment, generative artificial intelligence (GAI) is used to synthesize data to be used to train and/or validate a segmentation model. A GAI model may be fine tuned with real training data, but then may be able to generate its own data. The data is image data, and the GAI model may use a real background image and then generate a fake defect and insert the fake defect in the proper place in the real background image.

GAI refers to artificial intelligence systems that can create new content based on input data. This can include generating text, images, music, videos, and more. Unlike traditional AI, which may focus on analysis or classification tasks, generative AI models learn patterns from large datasets and use that knowledge to produce original outputs.

In an example embodiment, the GAI model used to synthesize data is a diffusion model. A diffusion model is a type of generative model used primarily in image generation and other tasks that involve data synthesis. It works by simulating a process that gradually transforms a simple distribution (like Gaussian noise) into a complex target distribution (like realistic images) through a series of steps.

A diffusion model involves a forward process and a reverse process. In the forward process, noise is gradually added to an image over several steps until the image becomes pure noise. The model then learns to reverse the noise addition process. It gradually removes the noise step-by-step to reconstruct the original data from the noisy version. Thus the model can start with random noise and iteratively refine it into a coherent image or sample. These iterations stop when a loss function is satisfied, or more precisely when the loss of the loss function is minimized. In diffusion models, the typical loss function is based on the variational lower bound of the data likelihood, often incorporating a form of the mean squared error (MSE) between the predicted and true noise at each time step. Specifically, the loss function can be formulated as

$$L ( θ ) = {Ex}_{0 , ϵ , t} [ ‖ ε - εθ ( xt , t ) ‖ 2 ]$$

Here x0 is the original data. ϵ is the noise sampled from a Gaussian distribution. xt is the noisy version of x0 at time t. ϵθ(xt, t) is the model's prediction of the noise at time t. θ represents the model parameters

The objective is to minimize this loss, enabling the model to accurately predict the noise, which in turn allows it to reverse the diffusion process and generate samples from the learned distribution.

Alternatively, a Large Language Model (LLM) may be used. In an LLM, a generative pre-trained transformer (GPT) model or a bidirectional encoder may be used. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and the discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational Auto-Encoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

While the solutions described herein can be applied using any GAI model, this disclosure will focus on the diffusion model embodiment. Nothing in this document, however, shall be interpreted as limiting the scope of protection to only diffusion model embodiments, however, unless expressly stated.

In the diffusion model embodiment, the diffusion model is fine-tuned using real data (images with masks/labels). This can be accomplished with as little as a single sample image and mask. This is performed as part of a fine-tuning workflow. The beginning of the fine-tuning workflow uses a cropping mechanism that is used to crop the image so that what remains is mostly just the labeled region of the image, which presumably means the area where the defect lies. Some of the non-labeled region surrounding the labeled region may be in the cropped image as well. The ratio of allowable non-labeled region-to-labeled region may be a configurable parameter.

The fine-tuning then occurs only on this cropped-down version of the image, rather than the original image. This makes the training more efficient and more useful in the case of being able to use the diffusion model later to generate training and validation data for the segmentation model. It also leads to higher quality generation as irrelevant information that can interfere with generation is reduced or eliminated.

When training occurs, as mentioned earlier, the diffusion model is run over and over again, modifying one or more parameters with each iteration, until it learns which parameters are best. At each iteration a checkpoint may be made, where the chosen parameters are saved. The validation portion of the process involves choosing which version of the diffusion model worked best, which essentially means choosing one of the checkpoints.

The selection of the checkpoint may be accomplished using another machine learning model. This may be called an embedding machine learning model. The embedding model generates an embedding for each training image that was used for the diffusion model. Thus, if there was only a single training image, then an embedding for that training image is generated by the embedding machine learning model. Regardless of how many training images are used, the mean of the embeddings of those training images may be calculated, and will be used later in the process.

An embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the images that are similar will have the corresponding similar embeddings.

The embedding machine learning model may itself be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the embedding machine learning algorithm used to train the embedding machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the embedding machine learning model may take place as a dedicated training phase. In other example embodiments, the embedding machine learning model may be retrained dynamically at runtime based on feedback.

In an example embodiment, the embedding machine learning model is itself part of an LLM. LLMs rely on embeddings as part of their processing.

During the training of the diffusion model, as mentioned earlier at each iteration a checkpoint is made. Additionally, in an example embodiment, at each iteration the version of the diffusion model at that iteration is used to generate a plurality of validation images. In an example embodiment, four validation images are generated at each iteration. Each of the plurality of images are passed through the embedding machine learning model to generate embeddings for each of the plurality of images.

The mean of the embeddings of each of the validation images is then computed. This mean may then be compared to the earlier calculated mean of the embeddings of each of the training images to obtain a similarity score. The similarity score indicates how similar the two means are, essentially indicating how similar the validation images are to the training images. In an example embodiment, the similarity score is calculated using cosine similarity.

In cosine similarity, the cosine of the angle between two vectors, such as embeddings, is computed. The cosine similarity of two embeddings will range from 0 to 1. If the cosine similarity is 1, it means the two embeddings have the same orientation and thus are identical. Values closer to 0 indicate less similarity. Other measures of similarity may be used, in lieu of or in addition to the cosine similarity, such as Euclidean distance and Jaccard similarity.

The result is that a cosine similarity score is generated at each iteration, which allows the iterations' corresponding checkpoints to be compared. The checkpoint with, for example, the highest similarity score when compared to the training images may be selected as the checkpoint to use at inference time. That is not true in all embodiments, however. In some example embodiments, the similarity score is merely one factor in which checkpoint is selected. For example, one may want to also factor in a need for variation in the generated images. The idea here would be to not only generate images that are similar to the training images for the diffusion model, but also generate images that have some variation to provide the best generated training set for the subsequent segmentation model. As such, the standard deviation of the embeddings of the images generated at each iteration may also be considered as a factor. In such embodiments, it may be desirable to choose the checkpoint in which both the similarity score and the standard deviation are maximized.

At inference time (when the diffusion model is used to actually synthesize data), a background image is selected. This background image may be, for example, an image of an actual product, but that may not contain a defect. The background image is cropped into a smaller image that contains the area where the defect will be generated. This speeds up the inference process. The speed of generation is proportional to the requested generation resolution. This smaller image is then used as input to the diffusion model with instructions to generate a defect into a portion of the smaller image. More specifically, a region of the smaller image is defined and passed to the diffusion model with instructions to generate the defect within the defined region. The region may be defined, for example, by a manual process where a user utilizes a graphical user interface to draw a boundary around an area in which a defect should be generated.

The diffusion model may then generate image data within the defined region based on a prompt and the input data. This generated image data can then be combined with the background image to complete the image synthesis.

The cropping helps set the right focus for the diffusion model. If an LLM is used, then this cropping may be optional since an LLM typically is designed with a greater ability to handle generation of background image.

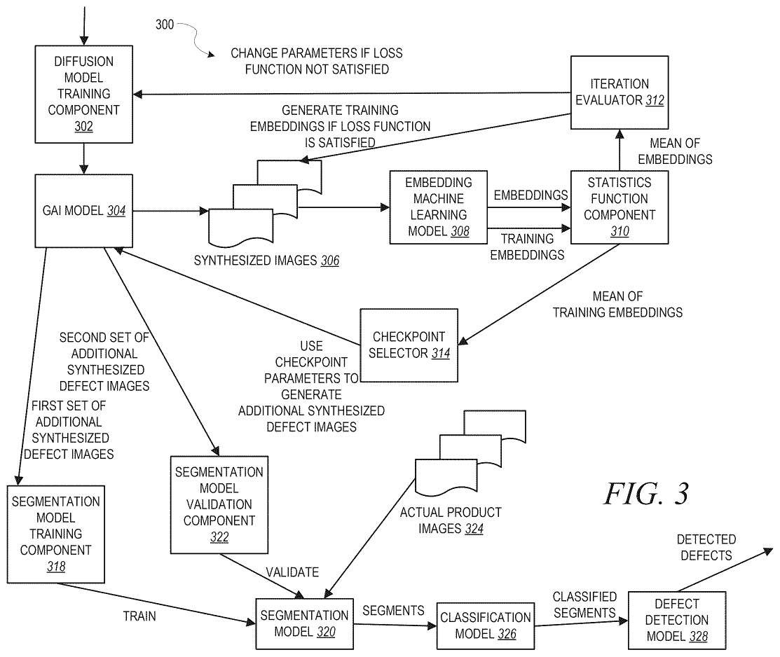

FIG. 3 is a block diagram illustrating a system 300, in accordance with an example embodiment. One or more training images are passed to a diffusion model training component 302. The diffusion model training component 302 acts to train a GAI model 304 based on the one or more training images. More specifically, each training image includes a depiction of a product and also having a corresponding mask, wherein the corresponding mask provides a label for one or more portions of the training image. More specifically, the one or more training images and corresponding masks are sent to the GAI model 304 with instructions to cause the GAI model to generate a plurality of images that depict a defect in the product, based on one or more parameters.

During training of the GAI model 304, at each iteration the one or more parameters are saved as a checkpoint and synthesized images 306 are generated. Each of these synthesized images are then input into an embedding machine learning model 308 to generate synthesized image embeddings, comprising a different embedding for each image in the plurality of images. A statistics function component 310 then computes a mean of the synthesized image embeddings. A training evaluator 312 then evaluates whether some predefined iteration criteria have been satisfied. If not, then another iteration is performed, changing at least some of the one or more parameters. This process repeats until the predefined iteration criteria have been satisfied. At each operation, a different set of synthesized images have been generated and a different mean of the embeddings of those synthesized images has been calculated.

Prior to the training of the diffusion model(s), each of the one or more training images are passed into the embedding machine learning model 308 to generate training image embeddings, comprising a different embedding for each image in the one or more training images. The statistics function component 310 then calculates a mean of the training image embeddings.

The, at the end of each iteration, a checkpoint selector 314 selects a checkpoint based on a comparison of the mean of the training image embeddings and the mean of the synthesized image embedding corresponding to each checkpoint. This may be performed by, for example, computing the cosine similarity of the means for each corresponding checkpoint and using that cosine similarity as a similarity score for the corresponding checkpoint. This similarity score can be used alone or in conjunction with other factors (such as standard deviation of the synthesized image embeddings) to select one of the checkpoints. The GAI model 304 is then used with one or more parameters corresponding to the selected checkpoint to generate synthesized defect images.

A first set of these synthesized defect images is then passed to a segmentation model training component 318 to train a segmentation model 320. This training may include a mixture of synthesized defect images and real defect images (if available). A second set of defect images is then passed to a segmentation model validation component 322 to validate the segmentation model 320. Note that this second set of defect images may include only real defect images. Once validated, the segmentation model can then be used to evaluate actual product images 324 and segment the actual product images 324 into segments. Optionally, aA classification model 326 then classifies the segments and a defect detection model 328 detects one or more defects in the classified segments. In some example embodiments, the outputs of the segmentation model 320 already contain classification information and thus a separate classification model 326 is not needed.

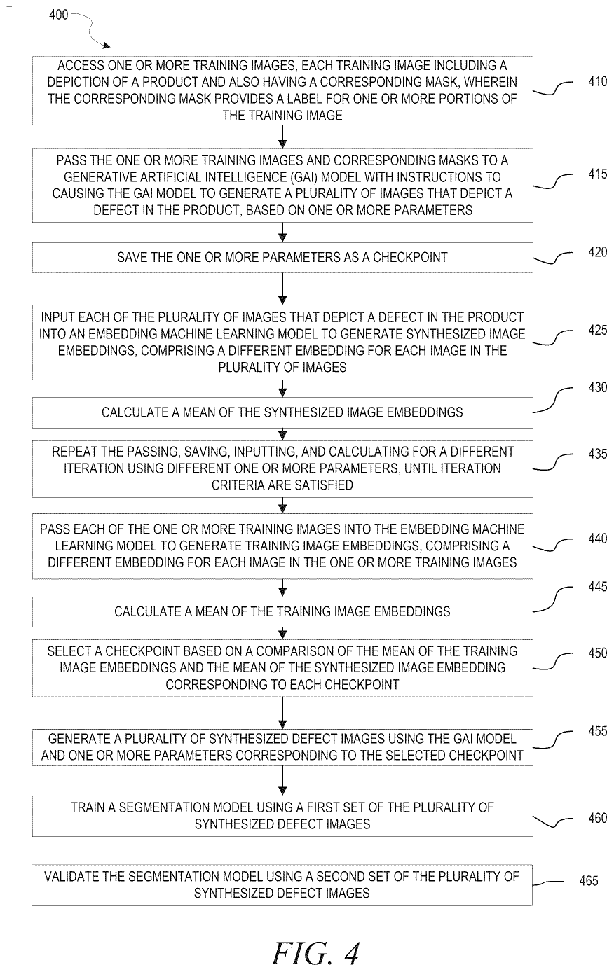

FIG. 4 is a flow diagram illustrating a method for training a segmentation model, in accordance with an example embodiment. At operation 410, one or more training images are accessed. Each training image includes a depiction of a product and also having a corresponding mask, wherein the corresponding mask provides a label for one or more portions of the training image. At operation 415, the one or more training images and corresponding masks are passed to a GAI model with instructions to causing the GAI model to generate a plurality of images that depict a defect in the product, based on one or more parameters.

At operation 420, the one or more parameters are saved as a checkpoint.

At operation 425, each of the plurality of images that depict a defect in the product is passed into an embedding machine learning model to generate synthesized image embeddings, comprising a different embedding for each image in the plurality of images. At operation 430, a mean of the synthesized image embeddings is calculated. At operation 435, iteration criteria are evaluated. If the iteration criteria are not satisfied (, then the method 400 loops back to operation 415 with some change to the one or more parameters. Thus, with each iteration, a checkpoint is created and a plurality of images are generated and embedded. Once the iteration criteria are satisfied, the method 400 moves to operation 440.

At operation 440, each of the one or more training images are passed into the embedding machine learning model to generate training image embeddings, comprising a different embedding for each image in the one or more training images. At operation 445, a mean of the training image embeddings is calculated. At operation 450, a checkpoint is selected based on a comparison of the mean of the training image embeddings and the mean of the synthesized image embedding corresponding to each checkpoint. This comparison may be, for example, a cosine similarity function. The selection may be based on the output of this cosine similarity function as well as other factors, such as the standard deviation of the synthesized image embeddings for each checkpoint.

At operation 455, a plurality of synthesized defect images are generated using the GAI model and one or more parameters corresponding to the selected checkpoint. At operation 460, a segmentation model is trained using a first set of the plurality of synthesized defect images and optionally real defect images. Optionally, at operation 465, the segmentation model is validated using a second set of defect images.

It should be noted that while points, lines, and circles are shown in these figures, example embodiments are not limited to these three types of geometric shapes, and indeed any two dimensional geometric shape may be identified by a user as being a region of interest.

In view of the disclosure above, various examples are set forth below. It should be noted that one or more features of an example, taken in isolation or combination, should be considered within the disclosure of this application.

Example 1 is a system comprising: one or more image data sources; a computer system comprising at least one hardware processor and a non-transitory computer-readable medium storing instructions that, when executed by the at least one hardware processor, cause the at least one hardware processor to perform operations comprising: accessing one or more training images, each training image comprising a depiction of a product and also having a corresponding mask, wherein the corresponding mask provides a label for one or more portions of the training image; passing the one or more training images and corresponding masks to a generative artificial intelligence (GAI) model with instructions to causing the GAI model to generate a plurality of images that depict a defect in the product, based on one or more parameters; saving the one or more parameters as a checkpoint; inputting each of the plurality of images that depict a defect in the product into an embedding machine learning model to generate synthesized image embeddings, comprising a different embedding for each image in the plurality of images; calculating a mean of the synthesized image embeddings; repeating the passing, saving, inputting, and calculating for a different iteration using different one or more parameters, until iteration criteria are satisfied; passing each of the one or more training images into the embedding machine learning model to generate training image embeddings, comprising a different embedding for each image in the one or more training images; calculating a mean of the training image embeddings; selecting a checkpoint based on a comparison of the mean of the training image embeddings and the mean of the synthesized image embedding corresponding to each checkpoint; generating a plurality of synthesized defect images using the GAI model and one or more parameters corresponding to the selected checkpoint; training a segmentation model using a first set of the plurality of synthesized defect images.

In Example 2, the subject matter of Example 1 comprises, wherein the operations further comprise: validating the segmentation model using a second set of the plurality of synthesized defect images.

In Example 3, the subject matter of Examples 1-2 comprises, wherein the GAI model is a Large Language Model (LLM).

In Example 4, the subject matter of Examples 1-3 comprises, wherein the GAI model is a diffusion model.

In Example 5, the subject matter of Example 4 comprises, wherein the operations further comprise: cropping the one or more training images based on corresponding masks; and wherein the plurality of synthesized defect images are each combined with a background image prior to being used to train the segmentation model.

In Example 6, the subject matter of Examples 1-5 comprises, wherein the embedding machine learning model is part of an LLM.

In Example 7, the subject matter of Examples 1-6 comprises, wherein the comparison comprises performing a cosine similarity function on the mean of the training image embeddings and the mean of the synthesized image embeddings corresponding to each checkpoint.

In Example 8, the subject matter of Example 7 comprises, wherein the operations further comprise: at each iteration, computing a standard deviation of the synthesized image embeddings for the corresponding checkpoint; and wherein the selecting is based on a combination of output of the cosine similarity function and the standard deviation for each corresponding checkpoint.

Example 9 is a method comprising: accessing one or more training images, each training image comprising a depiction of a product and also having a corresponding mask, wherein the corresponding mask provides a label for one or more portions of the training image; passing the one or more training images and corresponding masks to a generative artificial intelligence (GAI) model with instructions to causing the GAI model to generate a plurality of images that depict a defect in the product, based on one or more parameters; saving the one or more parameters as a checkpoint; inputting each of the plurality of images that depict a defect in the product into an embedding machine learning model to generate synthesized image embeddings, comprising a different embedding for each image in the plurality of images; calculating a mean of the synthesized image embeddings; repeating the passing, saving, inputting, and calculating for a different iteration using different one or more parameters, until iteration criteria are satisfied; passing each of the one or more training images into the embedding machine learning model to generate training image embeddings, comprising a different embedding for each image in the one or more training images; calculating a mean of the training image embeddings; selecting a checkpoint based on a comparison of the mean of the training image embeddings and the mean of the synthesized image embedding corresponding to each checkpoint; generating a plurality of synthesized defect images using the GAI model and one or more parameters corresponding to the selected checkpoint; training a segmentation model using a first set of the plurality of synthesized defect images.

In Example 10, the subject matter of Example 9 comprises, validating the segmentation model using a second set of the plurality of synthesized defect images.

In Example 11, the subject matter of Examples 9-10 comprises, wherein the GAI model is a Large Language Model (LLM).

In Example 12, the subject matter of Examples 9-11 comprises, wherein the GAI model is a diffusion model.

In Example 13, the subject matter of Example 12 comprises, cropping the one or more training images based on corresponding masks; and wherein the plurality of synthesized defect images are each combined with a background image prior to being used to train the segmentation model.

In Example 14, the subject matter of Examples 9-13 comprises, wherein the embedding machine learning model is part of an LLM.

In Example 15, the subject matter of Examples 9-14 comprises, wherein the comparison comprises performing a cosine similarity function on the mean of the training image embeddings and the mean of the synthesized image embeddings corresponding to each checkpoint.

In Example 16, the subject matter of Example 15 comprises, at each iteration, computing a standard deviation of the synthesized image embeddings for the corresponding checkpoint; and wherein the selecting is based on a combination of output of the cosine similarity function and the standard deviation for each corresponding checkpoint.

Example 17 is a non-transitory machine-readable storage medium having embodied thereon instructions executable by one or more machines to perform operations comprising: accessing one or more training images, each training image comprising a depiction of a product and also having a corresponding mask, wherein the corresponding mask provides a label for one or more portions of the training image; passing the one or more training images and corresponding masks to a generative artificial intelligence (GAI) model with instructions to causing the GAI model to generate a plurality of images that depict a defect in the product, based on one or more parameters; saving the one or more parameters as a checkpoint; inputting each of the plurality of images that depict a defect in the product into an embedding machine learning model to generate synthesized image embeddings, comprising a different embedding for each image in the plurality of images; calculating a mean of the synthesized image embeddings; repeating the passing, saving, inputting, and calculating for a different iteration using different one or more parameters, until iteration criteria are satisfied; passing each of the one or more training images into the embedding machine learning model to generate training image embeddings, comprising a different embedding for each image in the one or more training images; calculating a mean of the training image embeddings; selecting a checkpoint based on a comparison of the mean of the training image embeddings and the mean of the synthesized image embedding corresponding to each checkpoint; generating a plurality of synthesized defect images using the GAI model and one or more parameters corresponding to the selected checkpoint; training a segmentation model using a first set of the plurality of synthesized defect images.

In Example 18, the subject matter of Example 17 comprises, wherein the operations further comprise: validating the segmentation model using a second set of the plurality of synthesized defect images.

In Example 19, the subject matter of Examples 17-18 comprises, wherein the GAI model is a Large Language Model (LLM).

In Example 20, the subject matter of Examples 17-19 comprises, wherein the GAI model is a diffusion model.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

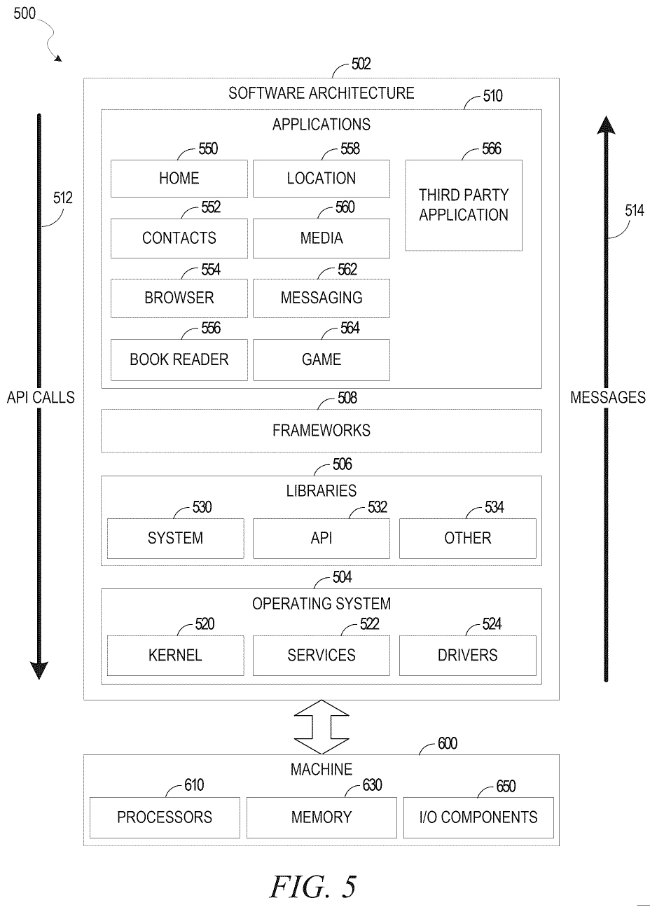

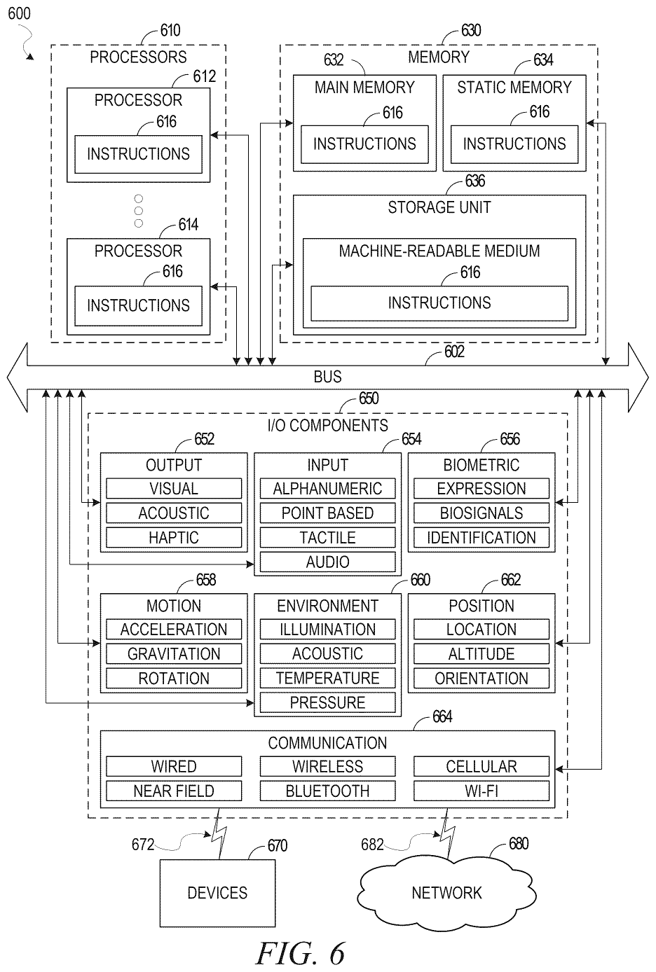

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke Application Program Interface (API) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510. For example, the frameworks 508 provide various graphical user interface functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. The applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) cause the machine 600 to perform any one or more of the methodologies discussed herein to be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., Hypertext Transfer Protocol [HTTP]). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
one or more image data sources;
a computer system comprising at least one hardware processor and a non-transitory computer-readable medium storing instructions that, when executed by the at least one hardware processor, cause the at least one hardware processor to perform operations comprising:
accessing one or more training images, each training image including a depiction of a product and also having a corresponding mask, wherein the corresponding mask provides a label for one or more portions of the training image;
passing the one or more training images and corresponding masks to a generative artificial intelligence (GAI) model with instructions to causing the GAI model to generate a plurality of images that depict a defect in the product, based on one or more parameters;
saving the one or more parameters as a checkpoint;
inputting each of the plurality of images that depict a defect in the product into an embedding machine learning model to generate synthesized image embeddings, comprising a different embedding for each image in the plurality of images;
calculating a mean of the synthesized image embeddings;
repeating the passing, saving, inputting, and calculating for a different iteration using different one or more parameters, until iteration criteria are satisfied;
passing each of the one or more training images into the embedding machine learning model to generate training image embeddings, comprising a different embedding for each image in the one or more training images;
calculating a mean of the training image embeddings;
selecting a checkpoint based on a comparison of the mean of the training image embeddings and the mean of the synthesized image embedding corresponding to each checkpoint;
generating a plurality of synthesized defect images using the GAI model and one or more parameters corresponding to the selected checkpoint;
training a segmentation model using a first set of the plurality of synthesized defect images.

2. The system of claim 1, wherein the operations further comprise:
validating the segmentation model using a second set of defect images.

3. The system of claim 1, wherein the GAI model is a Large Language Model (LLM).

4. The system of claim 1, wherein the GAI model is a diffusion model.

5. The system of claim 4, wherein the operations further comprise:
cropping the one or more training images based on corresponding masks; and
wherein the plurality of synthesized defect images are each combined with a background image prior to being used to train the segmentation model.

6. The system of claim 1, wherein the embedding machine learning model is part of an LLM.

7. The system of claim 1, wherein the comparison includes performing a cosine similarity function on the mean of the training image embeddings and the mean of the synthesized image embeddings corresponding to each checkpoint.

8. The system of claim 7, wherein the operations further comprise:
at each iteration, computing a standard deviation of the synthesized image embeddings for the corresponding checkpoint; and
wherein the selecting is based on a combination of output of the cosine similarity function and the standard deviation for each corresponding checkpoint.

9. A method comprising:
accessing one or more training images, each training image including a depiction of a product and also having a corresponding mask, wherein the corresponding mask provides a label for one or more portions of the training image;
passing the one or more training images and corresponding masks to a generative artificial intelligence (GAI) model with instructions to causing the GAI model to generate a plurality of images that depict a defect in the product, based on one or more parameters;
saving the one or more parameters as a checkpoint;
inputting each of the plurality of images that depict a defect in the product into an embedding machine learning model to generate synthesized image embeddings, comprising a different embedding for each image in the plurality of images;
calculating a mean of the synthesized image embeddings;
repeating the passing, saving, inputting, and calculating for a different iteration using different one or more parameters, until iteration criteria are satisfied;
passing each of the one or more training images into the embedding machine learning model to generate training image embeddings, comprising a different embedding for each image in the one or more training images;
calculating a mean of the training image embeddings;
selecting a checkpoint based on a comparison of the mean of the training image embeddings and the mean of the synthesized image embedding corresponding to each checkpoint;
generating a plurality of synthesized defect images using the GAI model and one or more parameters corresponding to the selected checkpoint;
training a segmentation model using a first set of the plurality of synthesized defect images.

10. The method of claim 9, further comprising:
validating the segmentation model using a second set of defect images.

11. The method of claim 9, wherein the GAI model is a Large Language Model (LLM).

12. The method of claim 9, wherein the GAI model is a diffusion model.

13. The method of claim 12, further comprising:
cropping the one or more training images based on corresponding masks; and
wherein the plurality of synthesized defect images are each combined with a background image prior to being used to train the segmentation model.

14. The method of claim 9, wherein the embedding machine learning model is part of an LLM.

15. The method of claim 9, wherein the comparison includes performing a cosine similarity function on the mean of the training image embeddings and the mean of the synthesized image embeddings corresponding to each checkpoint.

16. The method of claim 15, further comprising:
at each iteration, computing a standard deviation of the synthesized image embeddings for the corresponding checkpoint; and
wherein the selecting is based on a combination of output of the cosine similarity function and the standard deviation for each corresponding checkpoint.

17. A non-transitory machine-readable storage medium having embodied thereon instructions executable by one or more machines to perform operations comprising:
accessing one or more training images, each training image including a depiction of a product and also having a corresponding mask, wherein the corresponding mask provides a label for one or more portions of the training image;
passing the one or more training images and corresponding masks to a generative artificial intelligence (GAI) model with instructions to causing the GAI model to generate a plurality of images that depict a defect in the product, based on one or more parameters;
saving the one or more parameters as a checkpoint;
inputting each of the plurality of images that depict a defect in the product into an embedding machine learning model to generate synthesized image embeddings, comprising a different embedding for each image in the plurality of images;
calculating a mean of the synthesized image embeddings;
repeating the passing, saving, inputting, and calculating for a different iteration using different one or more parameters, until iteration criteria are satisfied;
passing each of the one or more training images into the embedding machine learning model to generate training image embeddings, comprising a different embedding for each image in the one or more training images;
calculating a mean of the training image embeddings;
selecting a checkpoint based on a comparison of the mean of the training image embeddings and the mean of the synthesized image embedding corresponding to each checkpoint;
generating a plurality of synthesized defect images using the GAI model and one or more parameters corresponding to the selected checkpoint;
training a segmentation model using a first set of the plurality of synthesized defect images.

18. The non-transitory machine-readable storage medium of claim 17, wherein the operations further comprise:
validating the segmentation model using a second set of defect images.

19. The non-transitory machine-readable storage medium of claim 17, wherein the GAI model is a Large Language Model (LLM).

20. The non-transitory machine-readable storage medium of claim 17, wherein the GAI model is a diffusion model.
